(19) United States
(12) Patent Application Publication
(10) Pub. No.: US 2024/0381472 A1
(43) Pub. Date: Nov. 14, 2024

(54) SYSTEMS AND METHODS FOR PORTING RULES TO WLAN

(71) Applicant: Meta Platforms Technologies, LLC, Menlo Park, CA (US)

(72) Inventors: Yousef Abdelmalek, New Providence, NJ (US); Jing Zhao, Chicago, IL (US); Mohamed El-Banna, Elk Grove, CA (US)

(21) Appl. No.: 18/195,612

(22) Filed: May 10, 2023

(51) Int. Cl. H04W 76/19; H04W 40/02

(52) U.S. Cl. CPC H04W 76/19; H04W 40/02

(57) ABSTRACT

The present solution provides to a user equipment (UE) on a WLAN, network resources of the WLAN matching those of a network slice provided to the UE on the cellular network. At least one network device intermediary between a WLAN and a cellular network can include at least one processor configured to identify a user equipment route selection policy (URSP) of the cellular network. The at least one processor can be configured to provision, according to the URSP, a set of resources of the WLAN for a wireless communication device on the WLAN. The at least one processor can be configured to establish a session for the wireless communication device to communicate via the WLAN and the cellular network, using the set of resources.

### TECHNICAL FIELD

The present implementations relate generally to wireless communications, and more particularly to management of network traffic across different networks.

### INTRODUCTION

Communication systems are increasingly expected to handle communication at higher volumes, with higher responsiveness and via a variety of connections and protocols. When communicating data across different networks, communication systems can have their data transmissions managed according to network traffic settings of the respective networks.

### SUMMARY

When a user equipment device (UE) accesses a wireless cellular network (e.g., a 4G or a 5G network) through fixed wireless access (FWA), the UE device can be assigned by the cellular network its own network slice for efficient communication via the cellular network. The network slicing functionality can support, for example, the UE's resource intensive (e.g., low-latency and high-bandwidth) communications with remote network devices. A UE Route Selection Policy (URSP) of the cellular network can be used to specify features of the network slice provided to the UE. However, as the URSP can be limited to the cellular network alone, the URSP can terminate at the FWA point (e.g., a modem or router of the WLAN), and therefore not be able to specify or provide network slicing to the UE device accessing the cellular network via the WLAN on the other side of the FWA point/system. As a result, UEs communicating via WLAN to reach their cellular networks on which their network slices are provided can run the risk of competing for resources with other UEs on the WLAN side of their connections. As a result, this can cause the UEs to fall short of securing sufficient resources to ensure their unimpeded and uninterrupted (e.g., resource-intensive) network communication.

The present disclosure addresses these issues by providing to the UE, on the WLAN side of the UE connection, network resources and functionalities matching (e.g., same as, similar to, or compatible with) those of the network slicing provided to the UE by the cellular network. In doing so, the present solution extends the functionality of the network slicing across the FWA system and over the threshold/boundary of the WLAN connection, allowing the UE to utilize on the WLAN the same or similar network functionality and resources as are provided to the UE on the cellular network.

Aspects of this technical solution are directed to a method. The method can include identifying, by at least one network device that is intermediary between a wireless local area network (WLAN) and a cellular network, a user equipment route selection policy (URSP) of the cellular network. The method can include provisioning, by the at least one network device according to the URSP, a set of resources of the WLAN for a wireless communication device on the WLAN. The method can include establishing, by the at least one network device, a session for the wireless communication device to communicate via the WLAN and the cellular network, using the set of resources.

The at least one network device can include at least one of a router, a modem or an access point. The wireless communication device can be configured to communicate with a server via the WLAN and the cellular network. The method can include receiving, by the at least one network device from the cellular network, the URSP. The method can include provisioning, by the at least one network device, the set of resources selected from resources of the WLAN. The method can include communicating, via the at least one network device, data between the wireless communication device and a server using the set of resources of the WLAN.

The set of resources of the WLAN can be configured to support a level of performance of a network slice of the cellular network assigned to the wireless communication device or an application of the wireless communication device. The method can include provisioning, by the at least one network device according to the URSP, for an application of the wireless communication device, the set of resources. The method can include communicating, via the at least one network device, data between the application and a server of the cellular network using the set of resources of the WLAN.

The method can include identifying, by the at least one network device, an application of the wireless communication device according to one or more application parameters of the URSP. The method can include provisioning, by the at least one network device, the set of resources for the application according to the one or more application parameters. The method can include receiving, by the at least one network device from the wireless communication device, a request to establish the session, the session comprising a protocol data unit (PDU) session. The method can include establishing, by the at least one network device responsive to the request, the PDU session in accordance with the set of resources of the WLAN.

The method can include identifying, by the at least one network device, a second URSP of the cellular network. The method can include provisioning, by the at least one network device according to the second URSP, a second set of resources of the WLAN for a second wireless communication device. The method can include establishing, by the at least one network device, a second session for the second wireless communication device to communicate via the WLAN and the cellular network, using the second set of resources.

The method can include receiving, by the at least one network device, an updated URSP of the cellular network. The method can include provisioning, by the at least one network device according to the updated URSP, an updated set of resources of the WLAN for the wireless communication device. The method can include reestablishing, by the at least one network device, the session for the wireless communication device to communicate via the WLAN and the cellular network, using the updated set of resources.

The method can include at least one network device intermediary between a wireless area network (WLAN) and a cellular network. The at least one network device can include at least one processor configured to identify a user equipment route selection policy (URSP) of the cellular network. The at least one processor can be configured to provision, according to the URSP, a set of resources of the WLAN for a wireless communication device on the WLAN. The at least one processor can be configured to establish a session for the wireless communication device to communicate via the WLAN and the cellular network, using the set of resources.

The at least one network device can include at least one of a router, a modem or an access point. The wireless communication device can be configured to communicate with a server via the WLAN and the cellular network. The at least one processor of the at least one network device can be configured to receive, from the cellular network, the URSP. The at least one processor can be configured to provision the set of resources selected from resources of the WLAN. The at least one processor can be configured to communicate, via the at least one network device, data between the wireless communication device and the server using the set of resources of the WLAN.

The set of resources of the WLAN can be configured to support a level of performance of a network slice of the cellular network assigned to the wireless communication device or an application of the wireless communication device. The at least one processor is configured to provision, according to the URSP, for an application of the wireless communication device, the set of resources. The at least one processor is configured to communicate, via the at least one network device, data between the application and a server of the cellular network using the set of resources of the WLAN.

The at least one processor can be configured to identify an application of the wireless communication device according to one or more application parameters of the URSP. The at least one processor can be configured to provision the set of resources for the application according to the one or more application parameters. The at least one processor can be configured to receive, from the wireless communication device, a request to establish the session, the session comprising a protocol data unit (PDU) session. The at least one processor can be configured to establish, responsive to the request, the PDU session in accordance with the set of resources of the WLAN.

The at least one processor can be configured to identify a second URSP of the cellular network. The at least one processor can be configured to provision, according to the second URSP, a second set of resources of the WLAN for a second wireless communication device. The at least one processor can be configured to establish a second session for the second wireless communication device to communicate via the WLAN and the cellular network, using the second set of resources.

The at least one processor can be configured to receive an updated URSP of the cellular network. The at least one processor can be configured to provision, according to the updated URSP, an updated set of resources of the WLAN for the wireless communication device. The at least one processor can be configured to reestablish the session for the wireless communication device to communicate via the WLAN and the cellular network, using the updated set of resources.

The at least one processor can be configured to be in communication with a non-transitory computer readable medium storing program instructions. The instructions can be for causing at least one processor of one or more network devices intermediary between a wireless area network (WLAN) and a cellular network to identify a user equipment route selection policy (URSP) of the cellular network. The instructions can be for causing the at least one processor to provision, according to the URSP, a set of resources of the WLAN for a wireless communication device on the WLAN. The instructions can be for causing the at least one processor to establish a session for the wireless communication device to communicate via the WLAN and the cellular network, using the set of resources.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment, according to an example implementation of the present disclosure.

FIG. 4 is a block diagram of an example system for providing extended network slicing support of a cellular network to a UE connecting to the cellular network via a WLAN.

FIG. 5 is a block diagram of an example system for providing extended network slicing support of a cellular (e.g., 5G/NR) network to a UE communicating over/from a Wi-Fi network.

FIG. 6 depicts an example of a method of providing extended network slicing support of a cellular network to a UE communicating over/from a Wi-Fi network.

FIG. 7 depicts an example of a method of providing extended network slicing support of a cellular network (e.g., 5G) to a UE connecting to the cellular network via a WLAN.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

This disclosure is directed to systems and methods for extending network slicing functionality provided to UE devices on a cellular network (e.g., 3GPP) across the threshold of the FWA system and onto a WLAN through which the UE devices access the cellular network. For example, a UE communicating over a cellular network can access the cellular network via a FWA system that can include a Wi-Fi modem and/or a router. A UE Route Selection Policy (URSP) of the cellular network can describe or specify (e.g., be used to identify/determine) the network slice assigned to the UE device (or to an application executing on the UE device) while communicating on the cellular network. However, as the URSP can terminate at the point of the FWA system, and may not extend into the WLAN (e.g., not supported on Wi-Fi connections, such as those operating on IEEE 802.11), the UEs can run the risk of competing for resources with other UEs connected on the Wi-Fi (e.g., on the WLAN side of the FWA system). Such competition for WLAN resources can cause the UEs to fall short of securing a sufficient amount and/or types of resources to ensure their unimpeded and uninterrupted resource-intensive network communication.

The present disclosure overcomes these challenges by providing to the UE device (or its application) resources and functionalities of the WLAN that can match, or correspond to, the operational level or quality of the network slice provided to the UE device by the cellular network. In doing so, the present solution can extend the effective network slicing functionality provided by the cellular network, over the threshold of the Wi-Fi (e.g., WLAN) connection and across the FWA system, thereby allowing the UE device to utilize on the WLAN side of the FWA system the same or similar operational level/resources for its network communication as enjoyed by the UE device on the cellular network. For example, the present solution can provide a list of registered UEs on the Wi-Fi of the FWA in order to pre-provision the UEs with default eMBB slices on the Wi-Fi side of the FWA, allowing the UEs to access their designed Wi-Fi side network slices. The present solution can also utilize a list of URSP rules of the cellular network to identify descriptor parameters of the network slice of an application of a UE on the cellular network side in order to provide a matching functionality and resources to the UE on the Wi-Fi side of the FWA. With this approach, the present solution can provide the UEs utilizing cellular network slicing, resources and functionalities of the cellular network slice on the Wi-Fi side of the connection, thereby matching the functionality of the cellular network slice across both the Wi-Fi and the cellular portion of the UE connection.

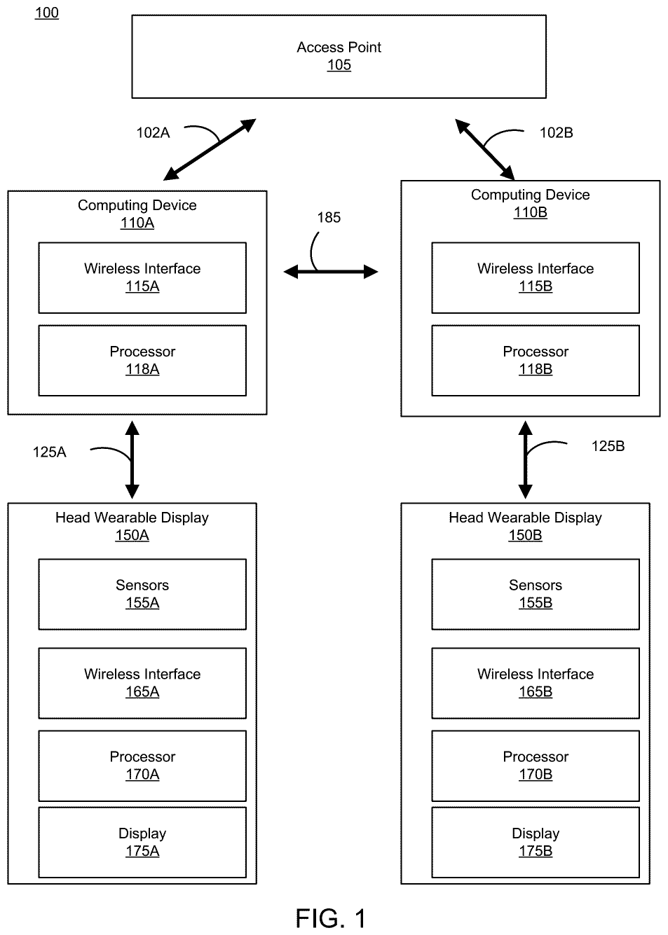

FIG. 1 is a block diagram of an example artificial reality system environment 100. In some embodiments, the artificial reality system environment 100 includes an access point (AP) 105, one or more HWDs 150 (e.g., HWD 150A, 150B), and/or one or more computing devices 110 (computing devices 110A, 110B; sometimes referred to as devices or consoles) providing data for artificial reality to the one or more HWDs 150. The computing devices and/or HWDs may comprise user devices. The access point 105 may be a router or any network device allowing one or more computing devices 110 and/or one or more HWDs 150 to access a network (e.g., the Internet). The access point 105 may be replaced by any communication device (cell site). A computing device 110 may be a custom device or a mobile device that can retrieve content from the access point 105, and provide image data of artificial reality to a corresponding HWD 150. Each HWD 150 may present the image of the artificial reality to a user according to the image data. In some embodiments, the artificial reality system environment 100 includes more, fewer, or different components than shown in FIG. 1. In some embodiments, the computing devices 110A, 110B communicate with the access point 105 through wireless links 102A, 102B (e.g., interlinks), respectively. In some embodiments, the computing device 110A communicates with the HWD 150A through a wireless link 125A (e.g., intralink), and the computing device 110B communicates with the HWD 150B through a wireless link 125B (e.g., intralink). In some embodiments, functionality of one or more components of the artificial reality system environment 100 can be distributed among the components in a different manner than is described here. For example, some of the functionality of the computing device 110 may be performed by the HWD 150. For example, some of the functionality of the HWD 150 may be performed by the computing device 110.

In some embodiments, the HWD 150 is an electronic component that can be worn by a user and can present or provide an artificial reality experience to the user. The HWD 150 may be referred to as, include, or be part of a head mounted display (HMD), head mounted device (HMD), head wearable device (HWD), head worn display (HWD) or head worn device (HWD). The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155, a wireless interface 165, a processor 170, and a display 175. These components may operate together to detect a location of the HWD 150 and a gaze direction of the user wearing the HWD 150, and render an image of a view within the artificial reality corresponding to the detected location and/or orientation of the HWD 150. In other embodiments, the HWD 150 includes more, fewer, or different components than shown in FIG. 1.

In some embodiments, the sensors 155 include electronic components or a combination of electronic components and software components that detects a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the wireless interface 165 includes an electronic component or a combination of an electronic component and a software component that communicates with the computing device 110. In some embodiments, the wireless interface 165 includes or is embodied as a transceiver for transmitting and receiving data through a wireless medium. The wireless interface 165 may communicate with a wireless interface 115 of a corresponding computing device 110 through a wireless link 125 (e.g., intralink). The wireless interface 165 may also communicate with the access point 105 through a wireless link (e.g., interlink). Examples of the wireless link 125 include a near field communication link, Wi-Fi direct, Bluetooth, or any wireless communication link. In some embodiments, the wireless link 125 may include one or more ultra-wideband communication links, as described in greater detail below. Through the wireless link 125, the wireless interface 165 may transmit to the computing device 110 data indicating the determined location and/or orientation of the HWD 150, the determined gaze direction of the user, and/or hand tracking measurement. Moreover, through the wireless link 125, the wireless interface 165 may receive from the computing device 110 image data indicating or corresponding to an image to be rendered.

In some embodiments, the processor 170 includes an electronic component or a combination of an electronic component and a software component that generates one or more images for display, for example, according to a change in view of the space of the artificial reality. In some embodiments, the processor 170 is implemented as one or more graphical processing units (GPUs), one or more central processing unit (CPUs), or a combination of them that can execute instructions to perform various functions described herein. The processor 170 may receive, through the wireless interface 165, image data describing an image of artificial reality to be rendered, and render the image through the display 175. In some embodiments, the image data from the computing device 110 may be encoded, and the processor 170 may decode the image data to render the image. In some embodiments, the processor 170 receives, from the computing device 110 through the wireless interface 165, object information indicating virtual objects in the artificial reality space and depth information indicating depth (or distances from the HWD 150) of the virtual objects. In one aspect, according to the image of the artificial reality, object information, depth information from the computing device 110, and/or updated sensor measurements from the sensors 155, the processor 170 may perform shading, re-projection, and/or blending to update the image of the artificial reality to correspond to the updated location and/or orientation of the HWD 150.

In some embodiments, the display 175 is an electronic component that displays an image. The display 175 may, for example, be a liquid crystal display or an organic light emitting diode display. The display 175 may be a transparent display that allows the user to see through. In some embodiments, when the HWD 150 is worn by a user, the display 175 is located proximate (e.g., less than 3 inches) to the user's eyes. In one aspect, the display 175 emits or projects light towards the user's eyes according to image generated by the processor 170. The HWD 150 may include a lens that allows the user to see the display 175 in a close proximity.

In some embodiments, the processor 170 performs compensation to compensate for any distortions or aberrations. In one aspect, the lens introduces optical aberrations such as a chromatic aberration, a pin-cushion distortion, barrel distortion, etc. The processor 170 may determine a compensation (e.g., predistortion) to apply to the image to be rendered to compensate for the distortions caused by the lens, and apply the determined compensation to the image from the processor 170. The processor 170 may provide the predistorted image to the display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a wireless interface 115 and a processor 118. These components may operate together to determine a view (e.g., a FOV of the user) of the artificial reality corresponding to the location of the HWD 150 and the gaze direction of the user of the HWD 150, and can generate image data indicating an image of the artificial reality corresponding to the determined view. The computing device 110 may also communicate with the access point 105, and may obtain AR/VR content from the access point 105, for example, through the wireless link 102 (e.g., interlink). The computing device 110 may receive sensor measurement indicating location and the gaze direction of the user of the HWD 150 and provide the image data to the HWD 150 for presentation of the artificial reality, for example, through the wireless link 125 (e.g., intralink). In other embodiments, the computing device 110 includes more, fewer, or different components than shown in FIG. 1.

In some embodiments, the wireless interface 115 is an electronic component or a combination of an electronic component and a software component that communicates with the HWD 150, the access point 105, other computing device 110, or any combination of them. In some embodiments, the wireless interface 115 includes or is embodied as a transceiver for transmitting and receiving data through a wireless medium. The wireless interface 115 may be a counterpart component to the wireless interface 165 to communicate with the HWD 150 through a wireless link 125 (e.g., intralink). The wireless interface 115 may also include a component to communicate with the access point 105 through a wireless link 102 (e.g., interlink). Examples of wireless link 102 include a cellular communication link, a near field communication link, Wi-Fi, Bluetooth, 60 GHz wireless link, ultra-wideband link, or any wireless communication link. The wireless interface 115 may also include a component to communicate with a different computing device 110 through a wireless link 185. Examples of the wireless link 185 include a near field communication link, Wi-Fi direct, Bluetooth, ultra-wideband link, or any wireless communication link. Through the wireless link 102 (e.g., interlink), the wireless interface 115 may obtain AR/VR content, or other content from the access point 105. Through the wireless link 125 (e.g., intralink), the wireless interface 115 may receive from the HWD 150 data indicating the determined location and/or orientation of the HWD 150, the determined gaze direction of the user, and/or the hand tracking measurement. Moreover, through the wireless link 125 (e.g., intralink), the wireless interface 115 may transmit to the HWD 150 image data describing an image to be rendered. Through the wireless link 185, the wireless interface 115 may receive or transmit information indicating the wireless link 125 (e.g., channel, timing) between the computing device 110 and the HWD 150. According to the information indicating the wireless link 125, computing devices 110 may coordinate or schedule operations to avoid interference or collisions.

The processor 118 can include or correspond to a component that generates content to be rendered according to the location and/or orientation of the HWD 150. In some embodiments, the processor 118 includes or is embodied as one or more central processing units, graphics processing units, image processors, or any processors for generating images of the artificial reality. In some embodiments, the processor 118 may incorporate the gaze direction of the user of the HWD 150 and a user interaction in the artificial reality to generate the content to be rendered. In one aspect, the processor 118 determines a view of the artificial reality according to the location and/or orientation of the HWD 150. For example, the processor 118 maps the location of the HWD 150 in a physical space to a location within an artificial reality space, and determines a view of the artificial reality space along a direction corresponding to the mapped orientation from the mapped location in the artificial reality space. The processor 118 may generate image data describing an image of the determined view of the artificial reality space, and transmit the image data to the HWD 150 through the wireless interface 115. The processor 118 may encode the image data describing the image, and can transmit the encoded data to the HWD 150. In some embodiments, the processor 118 generates and provides the image data to the HWD 150 periodically (e.g., every 11 ms or 16 ms).

In some embodiments, the processors 118, 170 may configure or cause the wireless interfaces 115, 165 to toggle, transition, cycle or switch between a sleep mode and a wake up mode. In the wake up mode, the processor 118 may enable the wireless interface 115 and the processor 170 may enable the wireless interface 165, such that the wireless interfaces 115, 165 may exchange data. In the sleep mode, the processor 118 may disable (e.g., implement low power operation in) the wireless interface 115 and the processor 170 may disable the wireless interface 165, such that the wireless interfaces 115, 165 may not consume power or may reduce power consumption. The processors 118, 170 may schedule the wireless interfaces 115, 165 to switch between the sleep mode and the wake up mode periodically every frame time (e.g., 11 ms or 16 ms). For example, the wireless interfaces 115, 165 may operate in the wake up mode for 2 ms of the frame time, and the wireless interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced.

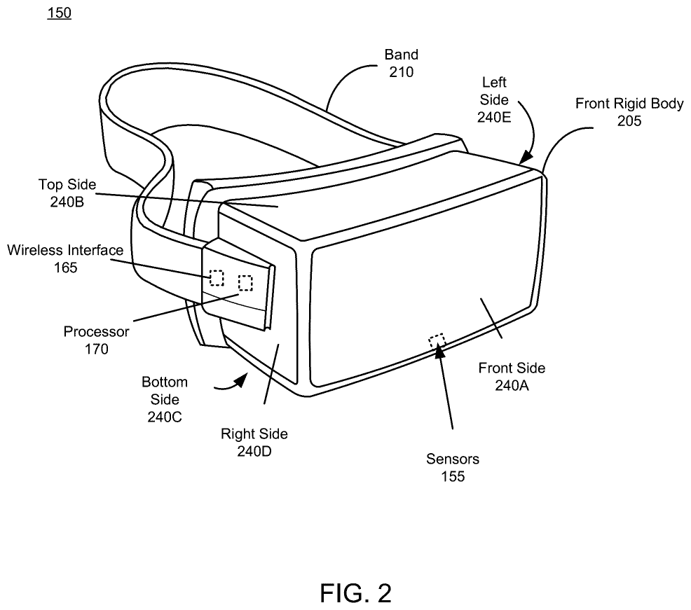

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens (not shown in FIG. 2), the sensors 155, the eye trackers the communication interface 165, and the processor 170. In the embodiment shown by FIG. 2, the sensors 155 are located within the front rigid body 205, and may not be visible to the user. In other embodiments, the HWD 150 has a different configuration than shown in FIG. 2. For example, the processor 170, the eye trackers, and/or the sensors 155 may be in different locations than shown in FIG. 2.

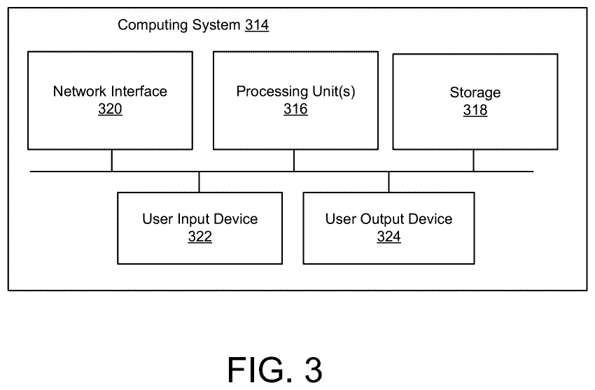

Various operations described herein can be implemented on computer systems. FIG. 3 shows a block diagram of a representative computing system 314 usable to implement the present disclosure. In some embodiments, the computing device 110, the HWD 150, devices 302, 304, or each of the components of FIG. 1-5 are implemented by or may otherwise include one or more components of the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, a server (e.g., an application server) or implemented with distributed computing devices. The computing system 314 can be provided or implemented to provide VR, AR, MR experience. In some embodiments, the computing system 314 can include computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, UWB, or cellular data network standards (e.g., 3G, 4G, 5G, 60 GHz, LTE, etc.).

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on. User input device 322 can be integrated with, coupled with or otherwise utilize memory, such as read only memory (ROM), random access memory (RAM), static random access memory (SRAM), dynamic random access memory (DRAM), flash memory or any other memory device.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on. User output device 324 can be integrated with, coupled with or otherwise utilize memory, such as read only memory (ROM), random access memory (RAM), static random access memory (SRAM), dynamic random access memory (DRAM), flash memory or any other memory device.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services. A processor 316 can be integrated with, coupled with or otherwise utilize memory, such as read only memory (ROM), random access memory (RAM), static random access memory (SRAM), dynamic random access memory (DRAM), flash memory or any other memory device.

Storage device 318 can include any device or a circuit for storing data. Storage device can include memory, such as read only memory (ROM), random access memory (RAM), static random access memory (SRAM), dynamic random access memory (DRAM), flash memory or any other memory device.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

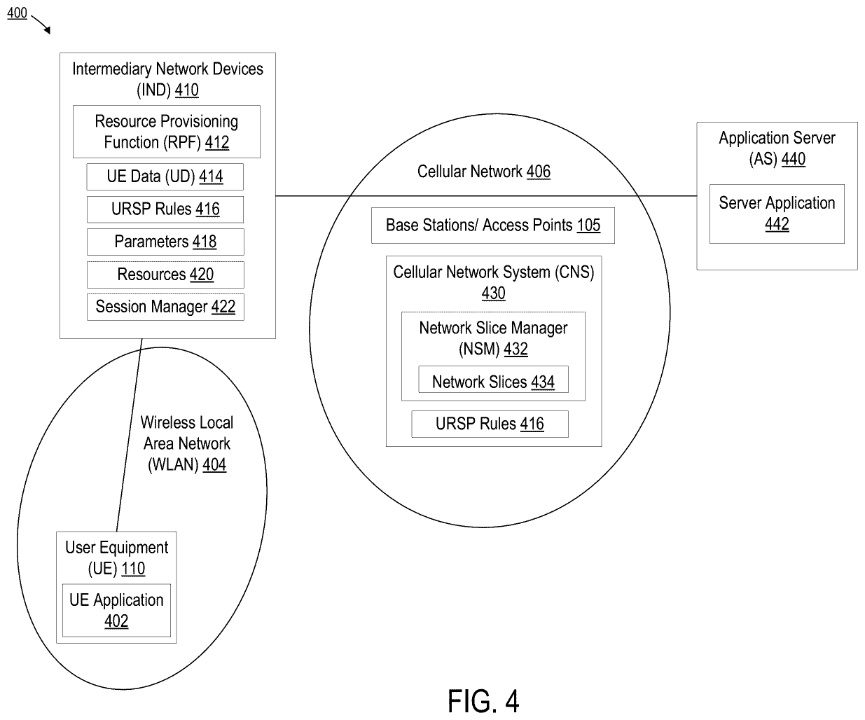

FIG. 4 depicts an example of a system 400 for providing, to a UE device on a WLAN, network resources matching or corresponding to the network slice provided to the UE device on the cellular network. System 400 can include one or more intermediary network devices (IND) 410 that can be deployed, located, positioned or otherwise disposed between a wireless local area network (WLAN) 404 and a cellular network 406. IND 410 can include one or more resource provisioning functions (RFP) 412, UE data (UD) 414, URSP rules 416, parameters 418, resources 420, session managers 422 and/or sets of resources 420. WLAN 404 can include, or be used for communication by, one or more UE 110. Each UE 110 can run one or more UE applications 402 for communicating across the WLAN 404 and cellular network 406. Cellular network 406 can include one or more base stations/access points 105 and cellular network systems (CNS) 430. CNS 430 can include one or more URSP rules 416 and network slice managers (NSM) 432 providing network slices 434. Across the cellular network 406 from the IND 410, can be one or more application servers (AS) 440. AS 440 can include one or more server applications 442 for communicating or exchanging data with the UEs 110 on the WLAN 404.

At a high level, an example system 400 can include one or more IND 410 (e.g., a modem, a Wi-Fi router and/or an access point) disposed between a WLAN 404 (e.g., Wi-Fi) and a cellular network 406 (e.g., 5G network). IND 410 can act as a proxy (e.g., intermediary, gateway, interface) between one or more UEs 110 on the WLAN 404 and the cellular network 406, via which the one or more UEs 110 can communicate with an application server 440. For example, a UE 110 can run/execute a UE application 402 to communicate, via WLAN 404 and via cellular network 406, with a server application 442 of an AS 440. CNS 430 can utilize NSM 432 to provide a network slice 434 to the UE 110. For instance, CNS 430 can provide, to the IND 410, one or more URSP rules 416 for providing the network slice 434 to the UE 110. IND 410 can utilize the received one or more URSP rules 416 to provision, via a RPF 412, from resources 420 of the WLAN 404, a set of resources 420 of the WLAN 404 for the communications of the UE 110. For example, RPF 412 can utilize UE data 414 to provision a set of resources 420 for the UE 110, or parameters 418 for UE applications 402 of the UE 110 to provision the set of resources 420 for specific UE applications 402 of the UE 110. When the UE 110 seeks access to the cellular network 406, a session manager 422 can establish a session (e.g., a PDU session) for the UE 110 using the provisioned set of resources 420. The provisioned set of resources 420 can provide the UE 110 with a matching or equivalent resource and functionality consistent with that of the network slice 434 provided to the UE 110 on the cellular network 406. The set of resources 420 can therefore effectively extend the network slicing support functionality of the cellular network 406 to the UE 110 across the IND 410 and over into the WLAN 404.

Executed on a UE 110, a UE application 402 can include any application communicating network traffic via a WLAN 404 and a cellular network 406. UE application 402 can include, for example, an AR/VR application (e.g., an AR/VR video game or interactive application), a video or audio streaming application. UE application 402 can include a resource intensive or a data intensive application that can generate, transmit or receive a large amount of time sensitive network traffic, such as network traffic that relies on high bandwidth and/or low latency communication. UE application 402 can use a large amount of bandwidth, such as up to 10 megabit per second (Mbps), 20 Mbps, 50 Mbps, 100 Mbps, 200 Mbps, 500 Mbps, 1000, 5000 Mbps, 10000 Mbps or more than 10000 Mbps. UE application 402 can operate at a low latency, such as a latency of up to 5 milliseconds (ms), 3 ms, 2 ms, 1 ms, 0.5 ms, 0.1 ms, 0.05 ms, or less than 0.05 ms.

UE application 402 can include, utilize or interact with a variety of functionalities, such as video or audio conferencing, video gaming, AR or VR displaying or any other resource or compute intensive functionality. UE application 402 can utilize various resources or functionalities of the networks (e.g., WLAN 404 or cellular network 406) for its operation, including for example, network slicing at high bandwidths, low latency, or specific security related network traffic treatment, such as a certain type of encryption, encoding, data encapsulation, or data routing to be applied to the network traffic of the UE application 402. UE application 402 can utilize one or more QoS treatments of the cellular network 406 corresponding to any network slices of a particular type, such as network slices configured to support a high bandwidth application, a low latency application, a high security (e.g., encrypted data) application, or any combination thereof.

UE application 402 can generate, transmit or receive network packets in a stream of data. The data stream can include a continuous flow of network packets, corresponding to any type of data, such as video data, audio data, control data, signaling data, connection or session management, sensor measurements or any other data type. UE application 402 can include, generate, transmit or receive any data including video, audio or text communication, data files, video gaming data stream, data for a partial virtual environment (AR), data for a complete virtual environment (VR), or any combination thereof.

The base station/access point 105 can correspond at least partially in one or more of structure and operation to the access point 105. The base station/access point 105 can be configured to communicate via, or to be compatible with communication via a wireless network protocol, such as a cellular network protocol of cellular network 406. Base station 105 can be configured to provide or communicate via a WLAN 404. For example, the base station/access point 105 can correspond to a base station 105 compatible with a cellular communication network, a cellular communication protocol (e.g., 3^{rd} Generation Partnership Project or 3GPP protocol), or any combination thereof. For example, the base station/access point 105 can correspond to an access point compatible with a wireless network communication network, a wireless network communication protocol, a protocol for communication via a WLAN 404, or any combination thereof.

Wireless local area network (WLAN) 404 can include any wireless network within a limited area covering one or more homes, buildings, streets or blocks or user devices. WLAN can include, for example, a Wi-Fi local area network or a Bluetooth local area network. WLAN 404 can include a wireless computer network linking two or more devices via wireless communication within an area such as a university or enterprise campus, office buildings. WLAN 404 can include, for example a campus area network (CAN) that can include one or more local area networks (LANs) of a school or business floor, a library or a home, as well as one or more personal area networks (PANs) of workspaces of one or more persons. WLAN 404 can be provided/accessed by any combination of one or more wired or wireless routers, modems and access points 105. WLAN 404 can include or support different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SD (Synchronous Digital Hierarchy) protocol. The ‘TCP/IP internet protocol suite can include application layer, transport layer, internet layer (including, e.g., IPv6), or the link layer.

The cellular network 406, also referred to as the network 406, can include any type or form of network providing cellular communication. The geographical scope of the cellular network 406 can vary widely and the network 406 can include a 3G/4G/5G/6G core network, a body area network (BAN), a personal area network (PAN), a local-area network (LAN), e.g. Intranet, a metropolitan area network (MAN), a wide area network (WAN), or the Internet. The topology of the network 406 can be of any form and can include, e.g., any of the following: point-to-point, bus, star, ring, mesh, or tree. Cellular network 406 can include an overlay network which is virtual and sits on top of one or more layers of other networks 406 or WLANs 404. The network 406 can be of any such network topology as known to those ordinarily skilled in the art capable of supporting the operations described herein. Network 406 can utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SD (Synchronous Digital Hierarchy) protocol. The ‘TCP/IP internet protocol suite can include application layer, transport layer, internet layer (including, e.g., IPv6), or the link layer. Cellular network 406 can include a type of a broadcast network, a telecommunications network, a data communication network, or a computer network. For example, the network 406 can correspond to or include a core network of a cellular communication system. The network 406 can include a cellular network system 430 that can include a network control channel, a network configuration interface, a communication session controller, a network configuration controller, an end point configuration controller, and/or a traffic controller.

Application server 440, also referred to as an AS 440 or a server 440, can include any network device exchanging communication with a UE 110. AS 440 can communicate with the UE 110 via one or more cellular networks 406 and one or more WLANs 404. AS 440 can execute an application function 442 that can generate and/or provide one or more streams of network packets to be accessed or received by UEs 110 across the cellular network 406 and WLAN 404. AS 440 can receive network packets from the UEs 110, via the cellular network 406 and WLAN 404.

Server application 442, also referred to as SA 442, can be executed or run on AS 440, and can include any functionality of a UE application 402. For example, SA 442 can include any application executing on a AS 440, such as an AR/VR application (e.g., an AR/VR video game or interactive application), a video or audio streaming application, a data intensive application utilizing a large amount of bandwidth at a low latency, a video or audio conferencing application or any other application executable on an AS 440. SA 442 can transmit and receive data streams comprising data packets of video, audio, text, signaling, control, AR, VR or any other type of data or payload. As with the data of the UE application 402, data of the SA 442 can be communicated, processed or serviced in accordance with one or more quality of service (QOS) treatments corresponding to one or more network slices 434 and in accordance with URSP rules 416. For example, data of the SA 442 and/or UE application 402 can be communicated via network slices 434 of a particular type, such as network slices 434 configured to support a high bandwidth application, a low latency application, a high security (e.g., specific types of data encryption, authentication or authorization protections) application functionalities, or any combination thereof.

Cellular network system 430 can include any combination of hardware and software for providing cellular network 406. Cellular network system 430 can include radio network distributed over a region via cells that can include fixed location base stations 105. Cellular network system can include a mobile core network that can include functionalities of the overall cellular network 406 to provide access to services that the UEs 110 can use. For example, CNS 430 can include a network configuration interface, which can include a network exposure function (NEF), such as a NEF of a 5G core system, or a service capability exposure function (SCEF), such as a SCEF of a 5G core system. For example, CNS 430 can include a communication session controller that can include a session management function (SMF), such as an SMF of a 5G core system. For example, CNS 430 can include a network configuration controller, which can include a policy control function (PCF), such as a PCF of a 5G core system. The PCF can include or provide a user-equipment route selection policy (URSP) and/or corresponding URSP rules 416 to identify and/or provide a network slice 434 designed for a UE 110 and/or UE application 402. For example, CNS 430 can include an end point configuration controller, which can include an access and mobility management function (AMF), such as an AMF of a 5G core system. For example, CNS 430 can include a user plane function (UPF), such as a UPF of a 5G core system, to communicate the network traffic via the cellular network 406

CNS 430 can include the functionality for providing QoS treatment to network data of the UE application 402 and/or SA 442. For example, a NEF or SCEF of the CNS 430 can include a network gateway configured as a perimeter control device of the network 406, including by providing authentication and authorization system to validate the AS 410 via encryption keys. For example, an SMF of the CNS 430 can include the communication session controller to control bidirectional communication via one or more nodes of the cellular network 406. For example, a PCF of the CNS 430 can generate, include, transmit or provide URSP that can be used to configure, set, or configure URSP rules for establishing or providing a network slice 434 of a UE application 402 and/or UE 110. For example, an AMF of the CNS 430 can include a network gateway configured as a perimeter control device of the network 406 to provide an authentication and authorization key validation system for base station/access point 105 and can instruct the base station/access point 105 to activate, deactivate, release, allocate, deallocate, or modify a communication session and can provide end point control. For example, a UPF of the CNS 430 can route, direct or communicate the network traffic of the UE application 402 and/or SA 442, via specific nodes and/or functions of the cellular network 406 in accordance with the QoS associated with the given network slice 434.

Network slice manager 432 can include any combination of hardware and software for managing, storing, providing network slices 434 to UEs 110 and/or UE applications 402. Network slice manager 432 can include the functionality to generate, assign and/or provide network slices 434 to UEs 110 and/or UE applications 402. Network slice manager 432 can store or access information or data for UE applications 402, such as parameters 418, to be used to access or use particular network slices 434. NSM 432 can include or store parameters 418 of UE applications 402 in order to match and provide the network slices 434 designated to particular UE applications 402 to the applications. Network slice manager 432 can be provided by a mobile network operator (MNO) of the CNS 430. NSM 432 can include a data repository or database for storing network slices 434, its corresponding data and/or parameters 418 corresponding to each of the network slices 434.

Network slice 434 can include any logical and virtualized network over a common network infrastructure. For example, a network slice 434 can include an independent logical portion of a cellular network 406 with a dedicated amount of resources, services or functionalities of the cellular network 406. For example, a network slice 434 can include an isolated end-to-end network configured, designed or otherwise set up to fulfill any amount or type of particular preferences or requirements of a UE application 402. For example, a network slice 434 can include a logical network with a sufficient amount of resources to provide a connection exceeding a particular threshold amount of bandwidth (e.g., high bandwidth network slice) and/or providing a communication below a particular (e.g., average) threshold latency (e.g., low latency network slice). Similarly, a network slice 434 can be configured or set up to satisfy any one or more security (e.g., encryption) level or communication or any combination of security, bandwidth or latency.

A user equipment route selection policy (URSP) rule 416 can include any rule for controlling or managing network data communication based on a user equipment route selection policy (URSP). URSP rule 416 can be used to indicate, provide or determine if a UE application 402 can use an already established protocol data unit (PDU) session or if there is a need to trigger the establishment of a new PDU session for the UE application 402. URSP rule 416 can also indicate if network traffic of a UE application 402 traffic can be offloaded to non-3GPP access outside a PDU session. URSP rule 416 can indicate or provide a bandwidth range (e.g., lower and/or upper limitation of the bandwidth) to be provided to a particular UE 110 and/or UE application 402. URSP rule 416 can indicate or provide a latency range (e.g., lower and/or upper limitation of the latency) to be provided to a particular UE 110 and/or UE application 402. URSP rule 416 can indicate or provide a network security service or settings (e.g., type of authentication or authorization to apply, type of encryption to utilize, routing path of the network traffic and other security related functionalities of the cellular network 406) to be provided to a particular UE 110 and/or UE application 402.

Intermediary network device (IND) 410 can include any combination of hardware and software for providing a communication interface between a WLAN 404 and a cellular network 406. IND 410 can include a fixed wireless access (FWA) system, such as, for example, one or more network devices that enable fixed broadband wireless access using radio frequencies. FWA system can facilitate or provide wireless access for a cellular network 406, such as a 5G or 4G LTE network. IND 410 can include one or more devices, such as any one or more, or any combination of, a modem 510, a router 505 and an access point 105. IND 410 can include a network switch, a transceiver, a gateway or a proxy device (e.g., a proxy server, an encoder or decoder device). IND 410 can include devices (e.g., router 505. modem 510 or access point 105) that can be configured to facilitate, provide or enable wireless network communication between various network devices on a WLAN 404 side, such as UEs 110 or HWDs 150 and various devices or functions on a CNS 430 or cellular network 406, such as base stations, 5G NR 515, or 5G Core 520. IND 410 can utilize a RPF 412 to provide, manage, assign and distribute resources 420 to various devices on the WLAN 404, such as UEs 110 or HWDs 150 in accordance with network slices 434 and/or URSP rules 416 for the network slices 434.

Resource provisioning function (RPF) 412 can include any functionality on the IND 410 for provisioning resources 420 to the UEs 110 for sessions or connections between the UEs 110 and the AS 440. RPF 412 can identify, manage, apportion, assign or otherwise provide one or more resources (e.g., a set of resources) of the WLAN 404 for a wireless communication device (e.g., UE 110) connected to, or communicating via, the WLAN 404. For example, RPF 412 can manage, apportion, assign or provide any resources for maintaining a particular level or quality (e.g., speed, bandwidth, reliability, security) of a connection or session of a UE 110 on WLAN 404, such as for example, computation, networking, storage, bandwidth or encryptions. RPF 412 can include and/or utilize one or more rules for assigning particular resources 420 to the UE 110. RPF 412 can assign or provision resources 420 of a WLAN 404 to a UE 110 according to URSP rules 416 or UE data 414, so as to match a particular network slice 434 utilized by the UE 110 on the cellular network 406. RPF 412 can provision or assign resources according to parameters 418 derived from, or generated based on, URSP rules 416 corresponding to network slices 434 of a particular UE 110 on the cellular network 406. RPF 412 can include the functionality to provision one or more resources 420 for a UE application 402 according to the one or more application parameters 418.

UE data (UD) 414 can include any information or data for a UE 110. UE data 414 can include data or information identifying a UE 110, such as for example an internet protocol (IP) address, MAC address, port identifier or other identification data. UE data 414 can correspond to UE 110 communication on WLAN 404 and/or cellular network 406. UE data 414 can include an identifier of a UE 110 on a cellular network 406. UE data 414 can include information or data corresponding to a particular network slice 434 utilized by a UE 110 on a cellular network 406, such as information identifying the network slice 434. UE data 414 can include data or information from or about URSP rules 416 and parameters 418.

Parameters 418 can include any data or information for specifying or establishing a set of resources 420 by the RPF 412. Parameters 418 can correspond to, indicate, specify or otherwise describe operational level, resource and/or functionality of a network slice 434. Parameters 418 can be used by the RPF 412 to identify, select, specify or assign one or more resources 420 to a UE 110 or UE application 402, such that the one or more resources 420 can provide a same, a similar, a matching or a corresponding level of performance to the UE 110 on the WLAN 404 as that provided on the cellular network 406. Parameters 418 can include values, setpoints or settings for various resources 420 of the WLAN 404. Parameters can indicate or correspond to computation power, bandwidth, network speed, latency, security or encryption settings, quality of service parameters on the cellular network 406 or any other information or data that can describe or indicate resources 420 to assign in order to match the quality of service of UE 110 communications on the cellular network 406. Parameters 418 can correspond to or identify an application 402 of a UE 110 according to one or more application parameters of URSP rules 416.

Resources 420 can include any combination of hardware devices, processing power, computer data or information that can be used to provide a particular level (e.g., quality, reliability, latency) of network connectivity (e.g., service) to a UE 110. Resources 420 can include processing capabilities of network devices (e.g., IND 410 routers, switches, modems, UE 110 processors), memory allocations for forwarding traffic, any form of data for providing a dedicated or a shared connection to a UE 110, or an expected bandwidth or latency. Resources 420 can include physical or functional aspects of physical devices (e.g., routers, cables, processors) as well as logical aspects for facilitating connections (e.g., ports, addresses or identifiers, URL or DNS records). Resources 420 can include route selection protocols, such as the DNN, network slice identifier and network access data or information. Resources 420 can include applications, files, instructions or data for establishing and facilitating network communication at a particular bandwidth or latency range for one or more UEs 110 on a WLAN 404. Resources 420 can relate to any hardware or logical aspects of WLAN 404 network for controlling rate and flow of network data to and from a UE 110 across the WLAN 404 and with respect to cellular network 406.

Session manager 422 can include any combination of hardware and software for establishing and managing communication sessions across WLAN 404 and cellular network 406. Session manager 422 can include the functionality for establishing a session for a UE 110 to communicate from the WLAN 404 and via cellular network 406, with AS 440 in accordance with the set of resources 420 assigned to the UE 110 on the WLAN 404 by the RPF 412 of the IND 410. Session manager 422 can maintain sessions for UEs 110 according to resources 420 assigned to the UEs 110 or UE applications 402.

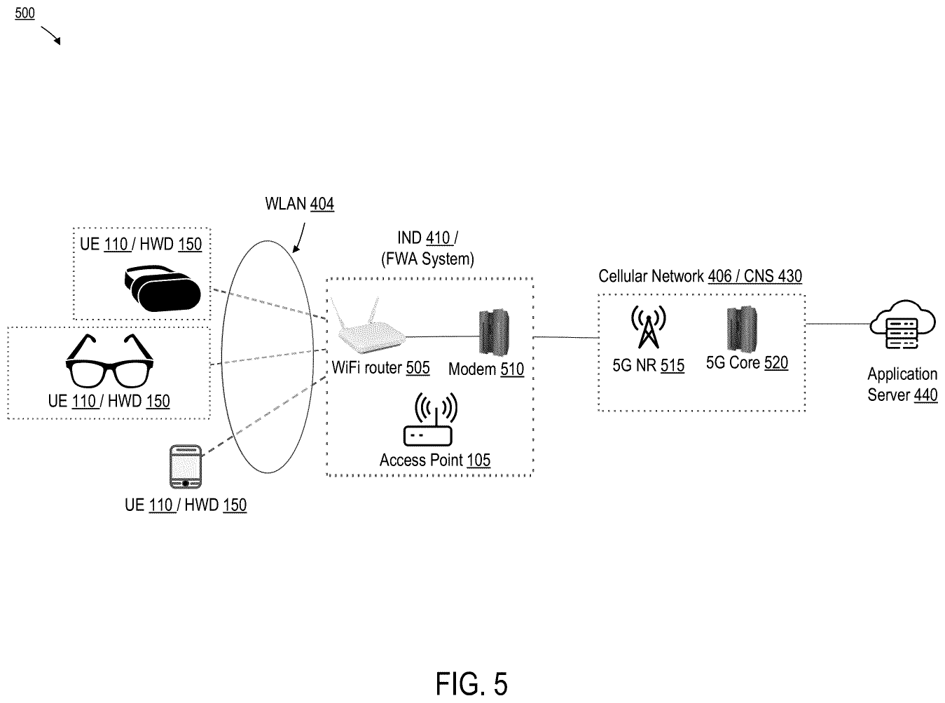

FIG. 5 illustrates a block diagram of an example system 500 for providing extended network slicing support of a cellular network 406 (e.g., a 5G network facilitated by a CNS 430) to UE 110 devices on a WLAN 404 (e.g., a Wi-Fi network). System 500 can utilize any functionality of system 400, and vice versa. System 500 can provide network communication to UE 110 devices or HWD 150 devices accessing cellular network 406 or CNS 430 from a WLAN 404 and via an IND 410 (e.g., FWA system). IN 410 (e.g., the FWA system) can include a Wi-Fi router 505, a modem 510 and/or an access point 105. The FWA system can facilitate communication between UE 110 devices or HWD 150 devices and CNS 430 components, such as 5G NR 515 and 5G core (network) 520, as well as any application servers 440 associated with the cellular network 406.

FWA system components can include a Wi-Fi router 505 for providing Wi-Fi access to a variety of UE 110 and HWD 150 devices via a WLAN 404. Wi-Fi router 505 can be communicatively coupled with a modem 510 that can further be in communication with the cellular network either directly or via an access point 105. Cellular network 406 or CNS 430 can include any range of devices or functionalities, such as a 5G new radio (NR) 515 device or functionality for mobile network communication. Cellular network 406 or CNS 430 can include 5G core (network) 520 which can include a variety of functionalities, such as an access and mobility management function (AMF) for managing user authentication and network access, a session management function (SMF) for managing data traffic routing and a network slice selection function (NSSF), such as an NSM 432, for selecting or providing a network slice 434 to a UE application 402.

In one example, the present solution can be directed to at least one network device (e.g., IND 410) that is intermediary (e.g., disposed or located) between a wireless area network (WLAN 404) and a cellular network 406. The IND 410 can include at least one processor 316 that can be coupled with memory storing instructions, data or information and configured to identify a user equipment route selection policy (URSP) of the cellular network. The URSP can correspond to a network slice 434 of the CNS 430 (e.g., 5G core system) on the cellular network 406. The network slice 434 can be a network slice of the 5G cellular network for a particular UE 110 on a WLAN 404 or a particular UE application 402 on the UE 110. The URSP can include or correspond to rules (e.g., URSP rules 416) specifying treatment or processing parameters (e.g., parameters 418) corresponding to the network traffic of the UE 110 and/or UE application 402 on the cellular network 406. The URSP can include or correspond to rules for establishing a low latency communication (e.g., a network connection having a particular acceptable latency threshold or range), a high bandwidth communication (e.g., a particular bandwidth threshold or range), a particular routing of network traffic, security settings or any other parameters 418, instructions, settings or data for processing or handling network traffic over a cellular network.

The IND 410 can include at least one processor 316 that can be coupled with memory storing instructions, data or information and configured to provision, according to the URSP, a set of resources 420 of the WLAN 404 for a wireless communication device (e.g., UE 110) on the WLAN 404. The set of resources 420 can match the parameters or URSP rules of the network slice 434. For example, the set of resources 420 provided by the IND 410 to the UE 110 or its UE application 402 can provide a matching network traffic treatment and operation (e.g., in terms of latency, bandwidth, level of security, network speed) to those provided by the network slice 434 of the same UE 110 or its UE application 402. The set of resources 420 can be identified, provisioned, provided or dedicated to the UE 110 and/or UE application 402 of the UE 110 based on, or in accordance with, data, information or parameters 418 corresponding to the URSP rules 416. IND 410 can, for example, allocate resources 420 of the WLAN 404 to the UE 110 or UE application 402 according to URSP or URSP rules 416. For example, IND 410 can allocate or dedicate device hardware of the IND 410, processing power or processing resources, memory resources, network routing resources, one or more sessions or connections on the WLAN 404, resources for ensuring or providing a particular latency range, bandwidth range or network traffic rate or speed to a session or communication between the UE 110 on the WLAN 404 and network devices external to WLAN 404.

The IND 410 can include at least one processor 316 that can be coupled with memory storing instructions, data or information and configured to establish a session for the wireless communication device (e.g., UE 110) to communicate via the WLAN and the cellular network, using the set of resources. The session can be a protocol data unit (PDU) session. The session can be established between the UE 110 and the AS 440 and via WLAN 404 and cellular network 406. The session can be established for network communication between UE application 402 on the UE 110 and a server application 442 on application server 440. The session can be established using, based on, or in accordance with the set of resources 420 of the WLAN 404. The communication between the UE 110 and the AS 440, via the PDU session, can be via the WLAN 404 and cellular network 406. The network traffic can be communicated over the cellular network 406 in accordance with the network slice 434 of the UE 110 and/or UE application 402.

The network traffic can be communicated over the WLAN 404 in accordance with the set of resources 420 matching (e.g., same as, similar to, compatible with) the operational parameters 418 of the network slice 434 of the UE 110 or UE application 402. The network traffic can be communicated over the WLAN 404 in accordance with the resources 420 that match the operational parameters of the network slice 434 to a particular tolerance. For example, the set of resources 420 selected or assigned to the UE 110 by the RPF 412 can operate to within 5%, 10%, 15%, 20% or 25% of the target/desired operational level. For example, the resources 420 can provide the latency of communication via WLAN 404 to within about 5%, 10%, 15%, 20% or 25% of the latency provided over the cellular network 406 based on the network slice 434. For example, the resources 420 can provide the bandwidth of communication via WLAN 404 to within about 5%, 10%, 15%, 20% or 25% of the bandwidth provided over the cellular network 406 based on the network slice 434. For example, the resources 420 can provide the network throughput rate or speed of communication via WLAN 404 to within about 5%, 10%, 15%, 20% or 25% of the network throughput rate or speed provided over the cellular network 406 based on the network slice 434. For example, the resources 420 can provide the security measures of communication via WLAN 404 to within about 5%, 10%, 15%, 20% or 25% of the security measures provided over the cellular network 406 based on the network slice 434.

The at least one network device of the IND 410 can include at least one, or any combination of a router 505, a modem 510 or an access point 105. The IND 410 can include a FWA device or a system. The IND 410 can include a single integrated device or a system or a plurality of devices or systems that can be communicatively coupled with each other. The wireless communication device (e.g., UE 110) can be configured to communicate with a server (e.g., AS 440) via the WLAN 404 and the cellular network 406. The IND 410 can proxy or route network traffic of the UE 110 and the AS 440 between the WLAN 404 and the cellular network 406.

The at least one processor 316 can be configured to receive the URSP, one or more URSP rules 416 or information or data on URSP rules 416 from the cellular network 406. The processor 316 can provide, assign or provision the set of resources 420 selected from resources of the WLAN 404. For example, the processor 316 can select resources 420 from a list of preconfigured resources. The list of preconfigured resources can include resources for providing a particular level of latency, bandwidth, network transmission rate, data routing, encoding or decoding rates, encryption or any other type of network traffic operation or performance. The resources can include device hardware of the IND 410, processing power or processing resources, memory resources, network routing resources, one or more sessions or connections on the WLAN 404, resources for ensuring or providing a particular latency range, bandwidth range or network traffic rate or speed to a session or communication between the UE 110 on the WLAN 404 and network devices external to WLAN 404. The at least one processor 316 can communicate data between the wireless communication device (e.g., UE 110) and the server (e.g., AS 440) via the at least one network device (e.g., IND 410) and using the set of resources of the WLAN 404.

The set of resources of the WLAN 404 can be configured to support a level of performance of a network slice 434 of the cellular network 406 assigned to the wireless communication device (e.g., UE 110) or an application 402 of the wireless communication device (e.g., UE 110). The network slice 434 can be an eMBB slice of a 5G cellular network. The level of performance of the network slice 434 can be partially or fully supported by the set of resources 420. For example, the set of resources 420 can provide a level of performance that is below the level of performance of the network slice 434 by up to about 5%, 10%, 15%, 20%, 25%, 50% or more than 50%. For example, the set of resources 420 can provide a level of performance that is above the level of performance of the network slice 434 by up to about 5%, 10%, 15%, 20%, 25%, 50% or more than 50%. For example, the set of resources 420 can provide a level of performance that matches the level of performance of the network slice 434 at about 5%, 10%, 15%, 20% or 25%.

The at least one processor 316 can be configured to provision for an application 402 of the wireless communication device (e.g., UE 110) the set of resources 420 according to the URSP. For example, the set of resources 420 provisioned to provide the network service to the UE 110 can match URSP rules 416 or parameters 418 corresponding to the operational performance of the network slice 434 on the cellular network 406. The at least one processor 316 can communicate data between the application 402 and a server (e.g., AS 440) of the cellular network 406 using the set of resources 420 of the WLAN 404, via the at least one network device (e.g., IND 410).

The at least one processor 316 can be configured to identify an application 402 of the wireless communication device (e.g., UE 110) according to one or more application parameters 418 of the URSP. For example, the at least one processor 316 can be configured to provision the set of resources 420 for the application 402 according to the one or more application parameters 418. The application parameters 418 can correspond to data, values or information for defining resources 420 to assign to the UE application 402 or UE 110 communications.

The at least one processor 316 can be configured to receive a request from the wireless communication device (e.g., UE 110) to establish the session for communication between the UE 110 and AS 440. For example, a session manager 422 can establish the session between the UE 110 and AS 440. For example, the session can include a protocol data unit (PDU) session. The processor 316 can establish, responsive to the request, the PDU session in accordance with the set of resources of the WLAN 404. The at least one processor 316 can be configured to identify a second URSP of the cellular network. The at least one processor 316 can be configured to provision, according to the second URSP, a second set of resources 420 of the WLAN for a second wireless communication device. The at least one processor 316 can be configured to establish a second session for the second wireless communication device to communicate via the WLAN 404 and the cellular network 406, using the second set of resources 420.

The at least one processor 316 can be configured to receive an updated URSP of the cellular network 406. The at least one processor 316 can be configured to provision, according to the updated URSP, an updated set of resources 420 of the WLAN 404 for the wireless communication device (e.g., UE 110). For example the RPF 412 can provide or provision the set of resources 420 according to parameters 418 indicative of the operational characteristics of the network slice 434 of the UE 110. The at least one processor 316 can be configured to reestablish the session for the wireless communication device (e.g., UE 110) to communicate via the WLAN 404 and the cellular network 406, using the updated set of resources 420.

In one aspect, the present solution relates to a non-transitory computer readable medium storing program instructions for causing at least one processor 316 of one or more network devices (e.g., IND 410) intermediary between a wireless area network (WLAN 404) and a cellular network 406, to identify a user equipment route selection policy (URSP) of the cellular network 406. The instructions can be for causing at least one processor 316 to provision, according to the URSP, a set of resources of the WLAN 404 for a wireless communication device (e.g., UE 110) on the WLAN 404. The instructions can be for causing the at least one processor 316 to establish a session for the wireless communication device (e.g., UE 110) to communicate via the WLAN 404 and the cellular network 406, using the set of resources 420.

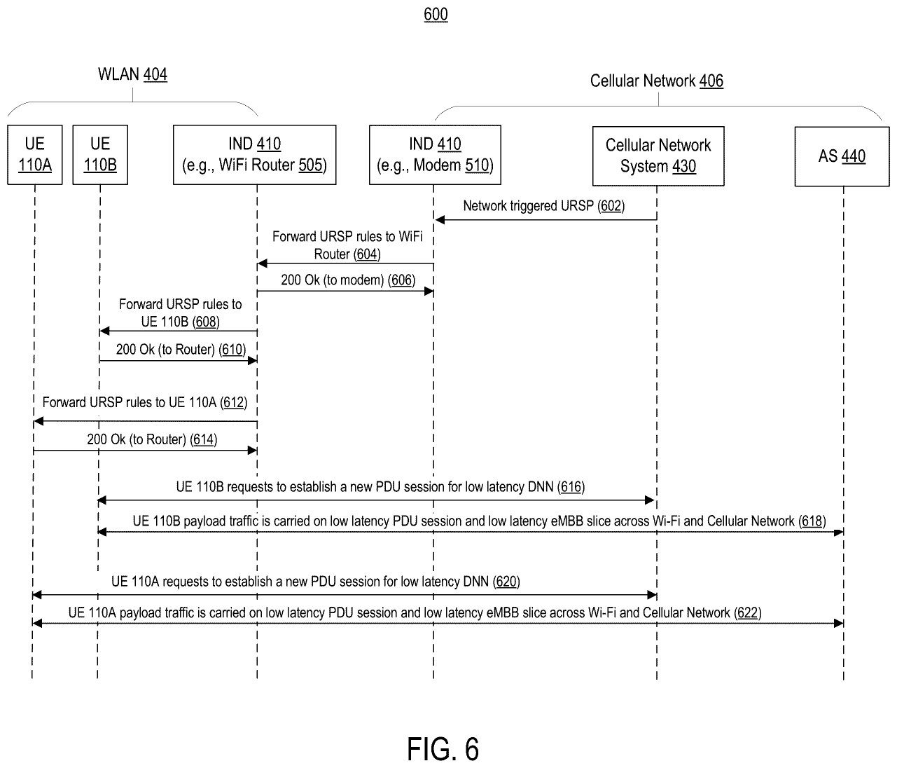

FIG. 6 depicts an example of a method 600 of providing extended network slicing support of a 5G cellular network to UE 110 devices communicating with the cellular network 406 via a WLAN 404 (e.g., Wi-Fi network). Method 600 can include acts 602 through 622 for provisioning a set of resources of a WLAN network to an application of a UE on the WLAN, to provide a network slicing functionality matching that of a network slice provided to the application on a cellular network.

At 602, method 600 can include a CNS of the cellular network triggering one or more URSP rules to the modem of the intermediary network devices (IND). At 604, method 600 can include the modem of the IND forwarding the one or more URSP rules to a Wi-Fi router of the IND. At 606, method 600 can include the Wi-Fi router of the IND responding to the modem of the IND with a confirmation (e.g., 200 OK) message. At 608, the method 600 can include the Wi-Fi router of the IND forwarding the one or more URSP rules to UE 110B on the WLAN network. At 610, the method 600 can include the UE 110B device responding to the Wi-Fi Router with a confirmation (e.g., 200 OK) message. At 612, the method 600 can include the Wi-Fi router of the IND forwarding the one or more URSP rules to UE 110A on the WLAN network. At 614, the method 600 can include the UE 110A device responding to the Wi-Fi Router with a confirmation (e.g., 200 OK) message. At 616, the method 600 can include UE 110B requesting from the CNS of the cellular network to establish a new PDU session for a low latency application or a low latency data network name (DNN). At 618, the method 600 can include the UE 110B communicating network traffic with the application server via a low latency PDU session and low latency enhanced mobile broadband (eMBB) network slice of the UE 110B across the Wi-Fi and the cellular network. At 620, the method 600 can include UE 110A device requesting from the CNS of the cellular network to establish a new PDU session for low latency DNN. At 622, the method 600 can include the UE 110A communicating network traffic with the application server via a low latency PDU session and low latency eMBB network slice of the UE 110A across the Wi-Fi and the cellular network.

At 602, a CNS of the cellular network can trigger a user equipment route selection policy (URSP) and one or more URSP rule,s and can send to the modem of the IND URSP, URPS rules or information (e.g., data or parameters) on the URSP or its rules. The URSP or its rules can be indicative or correspond to a network slice assigned to a particular UE 110 (e.g., UE 110A or UE 110B) or a particular application on a UE 110. The cellular network system (CNS) can send a network triggered URSP message to an IND device. For example, a CNS function of a cellular network can generate, retrieve and/or send one or more URSP rules for an application of a UE on a WLAN. The CNS can transmit to the IND a message including URSP rules, parameters or UE data corresponding to the UE device connected to the WLAN.

At 604, the modem of the IND can forward the one or more URSP rules to a Wi-Fi router of the IND. For example, the modem of the IND can forward to the router of the IND, URSP or URSP rules. The modem can forward to the router the information (e.g., data or parameters) on the URSP rules. The information or data on URSP rules forwarded to the router can include UE data, parameters or information for identifying the set of resources for provisioning a network slicing equivalent resources on the WLAN for the UE devices communicating, via the WLAN, with the cellular network utilizing their respective network slices.

At 606, the Wi-Fi router of the one or more intermediary network devices can respond to the modem of the IND with a confirmation (e.g., 200 OK) message. The message can include a string of characters, such as: 200 OK. The string of characters in the message can indicate that the URSP rules are received by the router, or that the transmission from act 604 has been successfully received.

At 608, the Wi-Fi router of the IND can forward the one or more URSP rules to UE 110B on the WLAN network. For example, the router can forward to the UE 110B (e.g., one of the UE devices on the WLAN) URSP or URSP rules, or information, parameters or data on URSP rules or URSP policy. For example, the router can transmit to the UE 110B information, data, parameters or other values for assigning, generating or provisioning the UE 110B with the set of resources of the WLAN providing a quality of service (e.g., bandwidth, latency, network speed, security settings) that matches that of the network slice for the UE 110B on the cellular network.

At 610, the UE 110B device can respond to the Wi-Fi Router with a confirmation (e.g., 200 OK) message. The message can include a string of characters, such as: 200 OK. The string of characters in the message can indicate that the URSP rules are received by the router, or that the transmission from act 608 has been successfully received.

At 612, the Wi-Fi router of the IND can forward the one or more URSP rules to UE 110A on the WLAN network. Similar to the actions at 608 with respect to UE 110B, the router of the IND can transmit to the UE 110A, URSP or its rules, or information, parameters or data on the URSP or its rules. At 612, the router can transmit to the UE 110A any information or data on the URSP or its rules, in accordance with the examples described at 608.

At 614, the UE 110A device can respond to the Wi-Fi Router with a confirmation (e.g., 200 OK) message. Similar to the actions at 610 with respect to UE 110B, the UE 110A can respond to the router with the 200 OK message, indicating that the transmission at 612 has been received.

At 616, the UE 110B can request from the CNS of the cellular network to establish a new PDU session for low latency DNN. An application of the UE 110B can try to establish a communication with application server (e.g., AS 440) and can send a request to establish a PDU session with the CNS. The new session can be a session with particular characteristics or requirements, such as a particular bandwidth amount, or for low latency, or for a particular network security (e.g., encryption or routing). The session can be requested from the CNS in accordance with the network slice for the UE 110B or a particular application executing on the UE 110B. The network slice can include its own parameters or characteristics, corresponding to the latency, bandwidth, network transmission speed or rate, network security settings or any network traffic quality of service related parameters.

At 618, the UE 110B can communicate network traffic with the application server via the PDU session and the corresponding eMBB network slice of the UE 110B across the Wi-Fi and the cellular network. For example, the UE 110B and the application server can communicate in accordance with the low latency parameters as established by the PDU session and/or network slice of the UE 110B. Likewise, UE 110B and the application server can communicate in accordance with any bandwidth, security or any other network traffic treatment settings or parameters.

At 620, the UE 110A device can request from the CNS of the cellular network to establish a new PDU session for low latency DNN. Just like at 616 with respect to the UE 110B, UE 110A can request from the CNS to establish a PDU session for the UE 110A using any actions or techniques discussed at 616.

At 622, the UE 110A can communicate network traffic with the application server via a low latency PDU session and low latency eMBB network slice of the UE 110A across the Wi-Fi and the cellular network. Just like at 618 with respect to the UE 110B, UE 110A can communication network traffic with the application server in accordance with the network slice of the UE 110A and any actions or techniques discussed at 618.

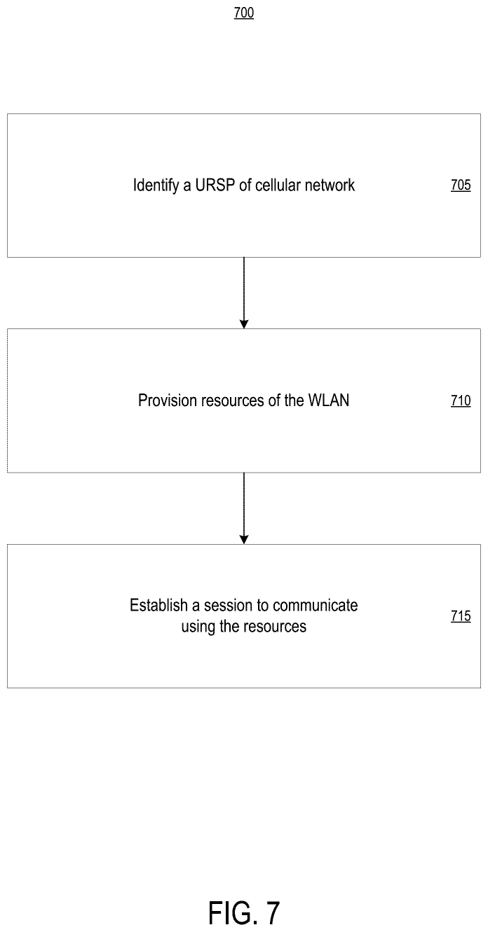

FIG. 7 depicts an example of a method 700 of providing to a UE reaching a cellular network through a WLAN, a set of WLAN resources corresponding to, or matching, the operational level/resources of the network slice provided to the UE by the cellular network (e.g., 5G). Method 700 can be implemented by a system, such as the system of example 400 or 500, or via any techniques, acts or embodiments described in connection with FIGS. 1-6. The method can include acts 705-715. At 705, the method can include identifying a URSP of a cellular network. At 710, the method can include provisioning resources of the WLAN. At 715, the method can include establishing a session for communication using the resources of the WLAN.

At 705, the method can include a cellular network system (e.g., a 5G core system) identifying a URSP of a cellular network. The URSP can correspond to a network slice assigned to or corresponding to wireless communication device (e.g., UE) on a WLAN. The cellular network system can generate or retrieve URSP corresponding to a network slice of a UE device or a UE application executing on the UE device. The URSP can specify, or correspond to, the quality of service of the network traffic to operate. The at least one network device (e.g., IND) intermediary between a wireless local area network (WLAN) and a cellular network can identify a user equipment route selection policy (URSP) of the cellular network. For example, the IND can identify the URSP by receiving the URSP from the cellular network system that can generate the URSP for a network slice. The at least one network device can include at least one of a router, a modem or an access point. The at least one network device (e.g., IND) can receive the URSP from the cellular network.

The set of resources of the WLAN can be configured to support a level of performance of a network slice of the cellular network assigned to the wireless communication device or an application of the wireless communication device. The network slice can include an eMBB slice. The level of performance of the network slice can be partially or fully supported by the set of resources. For example, the set of resources can provide a level of performance that is below the level of performance of the network slice by up to about 5%, 10%, 15%, 20%, 25%, 50% or more than 50%. For example, the set of resources can provide a level of performance that is above the level of performance of the network slice by up to about 5%, 10%, 15%, 20%, 25%, 50% or more than 50%. For example, the set of resources can provide a level of performance that matches (or is within) the level of performance of the network slice at about 5%, 10%, 15%, 20% or 25%.

The at least one network device can identify a second URSP of the cellular network. The second URSP can correspond to a second network slice for a second wireless communication device on the WLAN. The second URSP can correspond to a second one or more parameters 418 corresponding to a second URSP rules. The at least one network device can receive an updated URSP of the cellular network. The updated URSP can include or correspond to updated parameters 418 and updated URSP rules.

At 710, the method can include one or more intermediary network devices (e.g., router, modem and/or access point) provisioning resources of the WLAN to the wireless communication device (e.g., UE). The resources can be provisioned, provided or identified according to parameters indicative of the level of operation or operational functionality of the network slice of the particular wireless communication device (e.g., UE) on the cellular network. The at least one network device can provision a set of resources of the WLAN for a wireless communication device on the WLAN, according to the URSP. The wireless communication device (e.g., UE) can be configured to communicate with a server via the WLAN and the cellular network. The at least one network device can provision the set of resources selected from resources of the WLAN. The set of resources can be, for example, selected from a list of preconfigured resources. The list of preconfigured resources can include, for example, WLAN resources for providing a particular level of latency, bandwidth, network transmission rate, data routing, encoding or decoding rates, encryption or any other type of network traffic operation or performance. The resources can include device hardware of the intermediary network devices, processing power or processing resources, memory resources, network routing resources, one or more sessions or connections on the WLAN, resources for ensuring or providing a particular latency range, bandwidth range or network traffic rate or speed to a session or communication between the UE on the WLAN and network devices external to WLAN.

The at least one network device can utilize the resource provisioning function to provision the set of resources for an application of the wireless communication device, according to the URSP. The resource provisioning function can be deployed or executed on any one or more of a modem, a router or an access point of the one or more of intermediary network devices. The at least one network device can identify an application of the wireless communication device according to one or more application parameters of the URSP. The at least one network device can provision the set of resources for the application according to the one or more application parameters.

The at least one network device can provision, by the at least one network device, a second set of resources of the WLAN for a second wireless communication device. The second set of resources can be provisioned of a second wireless communication device on the WLAN in accordance with a second set of parameters corresponding to a second performance of the second network slice of the second wireless communication device on the cellular network. The at least one network device can provision, according to the updated URSP, an updated set of resources of the WLAN for the wireless communication device. The updated URSP can correspond to an updated set of parameters from which the resource provisioning function can provide an updated set of resources.

At 715, the method can include the one or more intermediary network devices (e.g., router, modem and/or access point) establishing a session for network communication of the wireless communication device (e.g., UE) using the resources of the WLAN. The method can include the at least one network device (e.g., of the IND) establishing, using the set of resources of the WLAN, a session for the wireless communication device to communicate via the WLAN and the cellular network. For example, the IND can utilize a session manager to establish the session. The session can be established in accordance with the set of resources of the WLAN. The set of resources of the WLAN can be established according to the parameters corresponding to the network slice associated with the wireless communication device (e.g., UE) on the cellular network.

The session can be a PDU session between UE and a remote server, such as an application server. The session can be between a UE application and a server application for communication via the WLAN and the cellular network. The set of resources provisioned for the UE and/or its application can provide a quality of service for network traffic of the UE and/or its application in accordance with the level of operation/service of the network slice of the UE and/or its application on the cellular network.

The method can include the at least one network device communicating data between the wireless communication device and a server using the set of resources of the WLAN. For example, the at least one network device can communicate the data between the application and a server of the cellular network using the set of resources of the WLAN. The at least one network device can receive, from the wireless communication device, a request to establish the session, the session comprising a protocol data unit (PDU) session.

The method can include establishing, by the at least one network device responsive to the request, the PDU session in accordance with the set of resources of the WLAN. For example, the at least one network device can establish a second session for the second wireless communication device to communicate via the WLAN and the cellular network, using the second set of resources. The at least one network device can reestablish the session for the wireless communication device to communicate via the WLAN and the cellular network, using the updated set of resources.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A method comprising:
identifying, by at least one network device intermediary between a wireless local area network (WLAN) and a cellular network, a user equipment route selection policy (URSP) of the cellular network;
provisioning, by the at least one network device according to the URSP, a set of resources of the WLAN for a wireless communication device on the WLAN; and
establishing, by the at least one network device, a session for the wireless communication device to communicate via the WLAN and the cellular network, using the set of resources.

2. The method of claim 1, wherein the at least one network device includes at least one of a router, a modem or an access point.

3. The method of claim 1, wherein the wireless communication device is configured to communicate with a server via the WLAN and the cellular network.

4. The method of claim 1, comprising:
receiving, by the at least one network device from the cellular network, the URSP;
provisioning, by the at least one network device, the set of resources selected from resources of the WLAN; and
communicating, via the at least one network device, data between the wireless communication device and a server using the set of resources of the WLAN.

5. The method of claim 1, wherein the set of resources of the WLAN is configured to support a level of performance of a network slice of the cellular network assigned to the wireless communication device or an application of the wireless communication device.

6. The method of claim 1, comprising:
provisioning, by the at least one network device according to the URSP, for an application of the wireless communication device, the set of resources; and
communicating, via the at least one network device, data between the application and a server of the cellular network using the set of resources of the WLAN.

7. The method of claim 1, comprising:
identifying, by the at least one network device, an application of the wireless communication device according to one or more application parameters of the URSP; and
provisioning, by the at least one network device, the set of resources for the application according to the one or more application parameters.

8. The method of claim 1, comprising:
receiving, by the at least one network device from the wireless communication device, a request to establish the session, the session comprising a protocol data unit (PDU) session; and
establishing, by the at least one network device responsive to the request, the PDU session in accordance with the set of resources of the WLAN.

9. The method of claim 1, comprising:
identifying, by the at least one network device, a second URSP of the cellular network;
provisioning, by the at least one network device according to the second URSP, a second set of resources of the WLAN for a second wireless communication device; and
establishing, by the at least one network device, a second session for the second wireless communication device to communicate via the WLAN and the cellular network, using the second set of resources.

10. The method of claim 1, comprising:
receiving, by the at least one network device, an updated URSP of the cellular network;
provisioning, by the at least one network device according to the updated URSP, an updated set of resources of the WLAN for the wireless communication device; and
reestablishing, by the at least one network device, the session for the wireless communication device to communicate via the WLAN and the cellular network, using the updated set of resources.

11. At least one network device intermediary between a wireless area network (WLAN) and a cellular network, comprising:
at least one processor configured to:
identify a user equipment route selection policy (URSP) of the cellular network;
provision, according to the URSP, a set of resources of the WLAN for a wireless communication device on the WLAN; and
establish a session for the wireless communication device to communicate via the WLAN and the cellular network, using the set of resources.

12. The at least one network device of claim 11, wherein:
the at least one network device includes at least one of a router, a modem or an access point; and
the wireless communication device is configured to communicate with a server via the WLAN and the cellular network.

13. The at least one network device of claim 11, wherein the at least one processor is configured to:
receive, from the cellular network, the URSP; and
provision the set of resources selected from resources of the WLAN; and
communicate, via the at least one network device, data between the wireless communication device and the server using the set of resources of the WLAN.

14. The at least one network device of claim 11, wherein the set of resources of the WLAN is configured to support a level of performance of a network slice of the cellular network assigned to the wireless communication device or an application of the wireless communication device.

15. The at least one network device of claim 11, wherein the at least one processor is configured to:
provision, according to the URSP, for an application of the wireless communication device, the set of resources; and
communicate, via the at least one network device, data between the application and a server of the cellular network using the set of resources of the WLAN.

16. The at least one network device of claim 11, wherein the at least one processor is configured to:
identify an application of the wireless communication device according to one or more application parameters of the URSP; and
provision the set of resources for the application according to the one or more application parameters.

17. The at least one network device of claim 11, wherein the at least one processor is configured to:
receive, from the wireless communication device, a request to establish the session, the session comprising a protocol data unit (PDU) session; and
establish, responsive to the request, the PDU session in accordance with the set of resources of the WLAN.

18. The at least one network device of claim 11, wherein the at least one processor is configured to:
identify a second URSP of the cellular network;
provision, according to the second URSP, a second set of resources of the WLAN for a second wireless communication device; and
establish a second session for the second wireless communication device to communicate via the WLAN and the cellular network, using the second set of resources.

19. The at least one network device of claim 11, wherein the at least one processor is configured to:
receive an updated URSP of the cellular network;
provision, according to the updated URSP, an updated set of resources of the WLAN for the wireless communication device; and
reestablish the session for the wireless communication device to communicate via the WLAN and the cellular network, using the updated set of resources.

20. A non-transitory computer readable medium storing program instructions for causing at least one processor of one or more network devices intermediary between a wireless area network (WLAN) and a cellular network to:
identify a user equipment route selection policy (URSP) of the cellular network;
provision, according to the URSP, a set of resources of the WLAN for a wireless communication device on the WLAN; and
establish a session for the wireless communication device to communicate via the WLAN and the cellular network, using the set of resources.
